(19) United States
(12) Patent Application Publication
(10) Pub. No.: US 2026/0203999 A1
(43) Pub. Date: Jul. 16, 2026

(54) OBJECT-DEPENDENT DRAW DISTANCE

(71) Applicant: thinAir Technologies, Inc., Covington, LA (US)

(72) Inventor: Jeremey Charbonnet, Covington, LA (US)

(21) Appl. No.: 19/444,834

(22) Filed: Jan. 9, 2026

Related U.S. Application Data
(60) Provisional application No. 63/745,716, filed on Jan. 15, 2025.

(51) Int. Cl. G06T 15/20

(52) U.S. Cl. CPC G06T 15/20; G06T 2210/36

(57) ABSTRACT

In one implementation, a method of rendering objects is performed by a device including one or more processors and non-transitory memory. The method includes storing first object data for a first object including a location of the first object in an environment. The method includes storing second object data for a second object including a location of the second object in the environment. The method includes determining a location of a perspective in the environment. The method includes determining a first distance between the location of the perspective and the location of the first object. The method includes determining a second distance between the location of the perspective and the location of the second object. The method includes, in accordance with a determination that the first distance is less than a first draw distance, rendering the first object from the perspective. The method includes, in accordance with a determination that the second distance less than a second draw distance less than the first draw distance, rendering the second object from the perspective.

### CROSS-REFERENCES TO RELATED APPLICATIONS

This application claims priority to U.S. Provisional Patent App. No. 63/745,716, filed on Jan. 15, 2025, which is hereby incorporated by reference in its entirety.

### TECHNICAL FIELD

The present disclosure generally relates to systems, methods, and devices of displaying a virtual environment.

### BACKGROUND

In various implementations, rendering a virtual environment for display includes rendering multiple objects at different depths.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1H illustrate a virtual environment during various time periods in accordance with some implementations.

FIG. 2 is a flowchart representation of a method of rendering objects in accordance with some implementations.

FIG. 3 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for rendering a virtual environment. In various implementations, the method is performed by a device having one or more processors and non-transitory memory. The method includes storing first object data for a first object including a location of the first object in an environment. The method includes storing second object data for a second object including a location of the second object in the environment. The method includes determining a location of a perspective in the environment. The method includes determining a first distance between the location of the perspective and the location of the first object. The method includes determining a second distance between the location of the perspective and the location of the second object. The method includes, in accordance with a determination that the first distance is less than a first draw distance, rendering the first object from the perspective. The method includes, in accordance with a determination that the second distance less than a second draw distance less than the first draw distance, rendering the second object from the perspective.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, rendering a virtual environment for display includes rendering multiple objects at different depths. In various implementations, as the distance between a rendering perspective and an object increases, the level of detail is decreased. Further, objects at a distance from the rendering perspective greater than a perspective draw distance are not rendered at all.

In various implementations, certain objects are associated with other objects in a parent-child relationship. Thus, in various implementations, a first object is a parent object of a second object which is a child object of the first object. When a parent object is transformed (e. g,, moved, rotated, or scaled), the child object is similarly transformed. Thus, three-dimensional coordinates defining the location of the child object may be specified in reference to the parent object rather than the virtual environment.

In various implementations, the level of detail is decreased by decreasing the number of polygons of a mesh of the object. For example, in various implementations, a sphere is rendered with thousands of polygons when rendered close to the rendering perspective, but is rendered as a dodecahedron (with 12 polygons) when rendered far from the rendering perspective.

In various implementations, the level of detail is decreased by decreasing a resolution of a material applied to the mesh of the object. For example, in various implementations, a material with a high resolution is applied when rendered close to the rendering perspective, but is rendered with a low resolution when rendered far from the rendering perspective.

In various implementations, the level of detail of a parent object is decreased by decreasing a number of rendered child objects. For example, in various implementations, a parent object is rendered with all of its child objects when rendered close to the rendering perspective, but is rendered with less than all of its child objects when rendered far from the rendering perspective. Thus, each child object has an object-dependent draw distance. In general, the level of detail of an object can be decreased to zero at an object-dependent draw distance at which the object is no longer rendered.

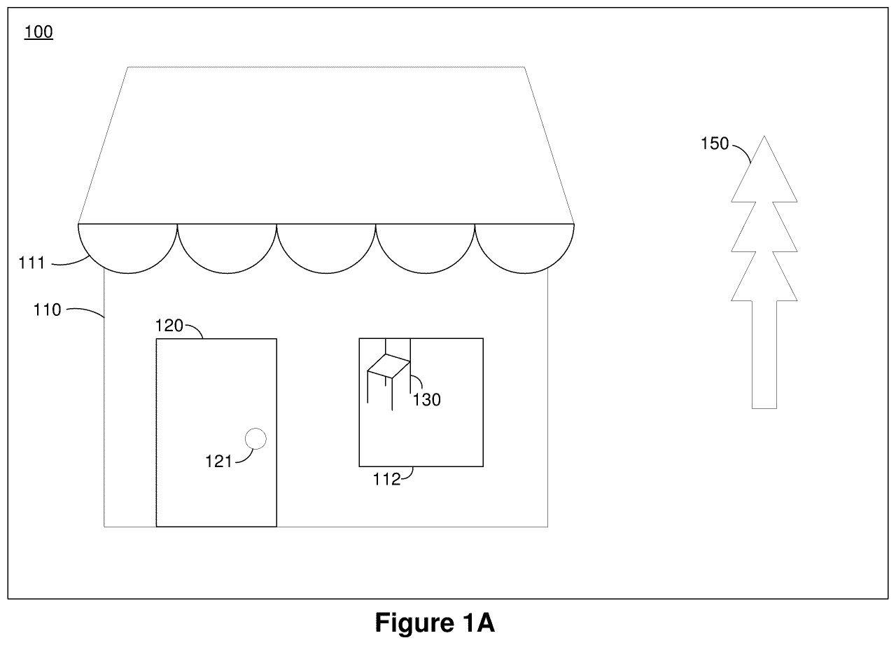

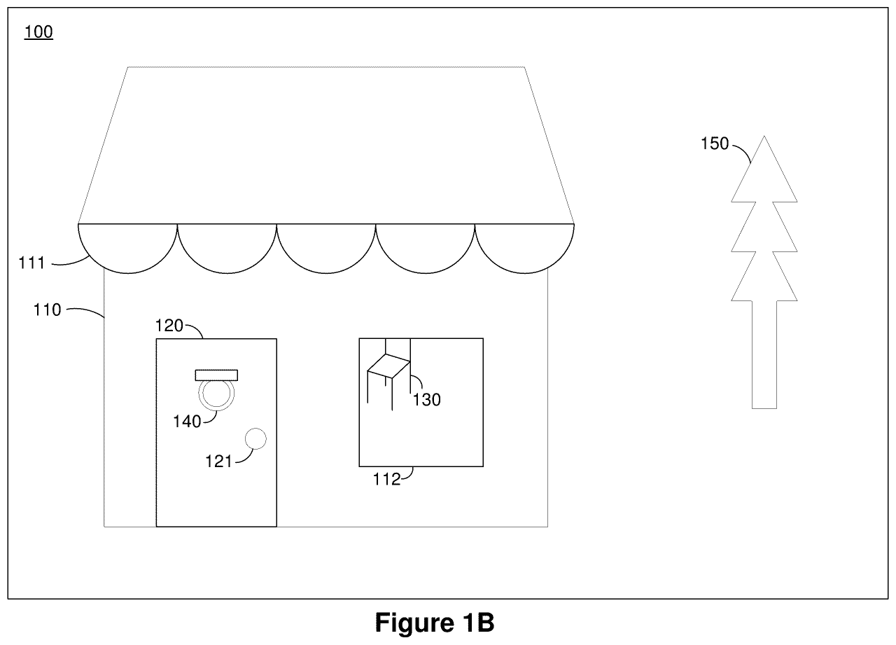

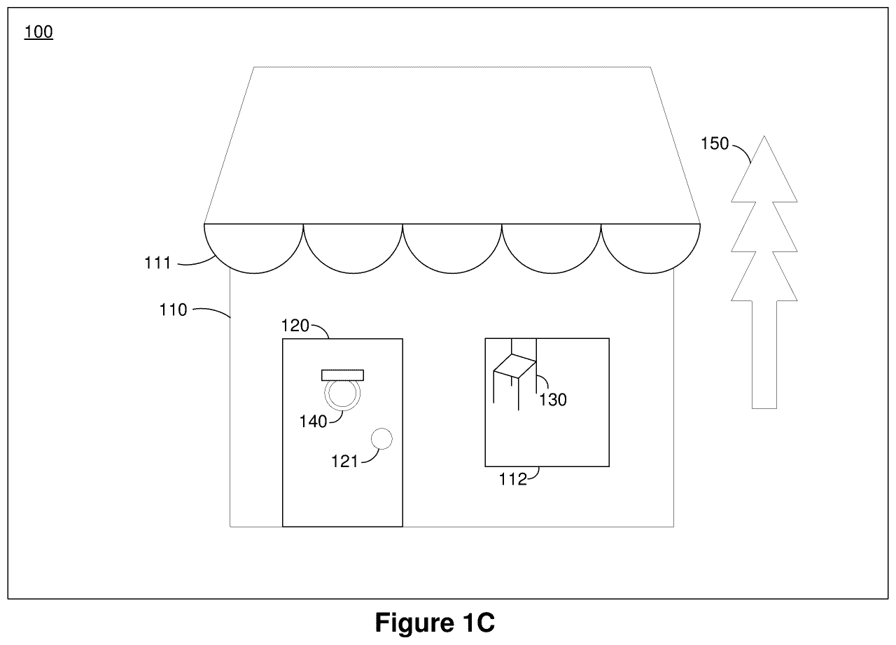

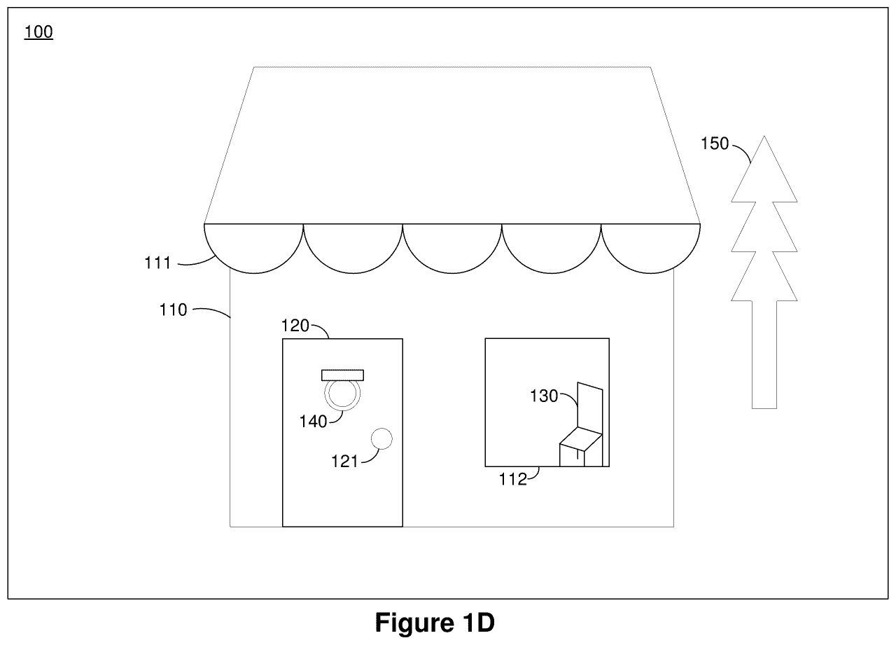

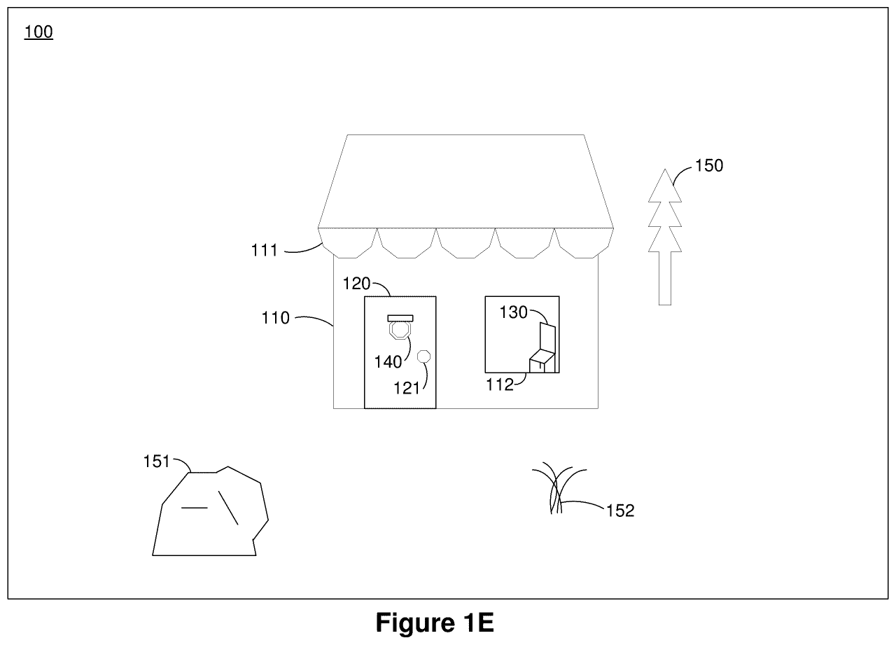

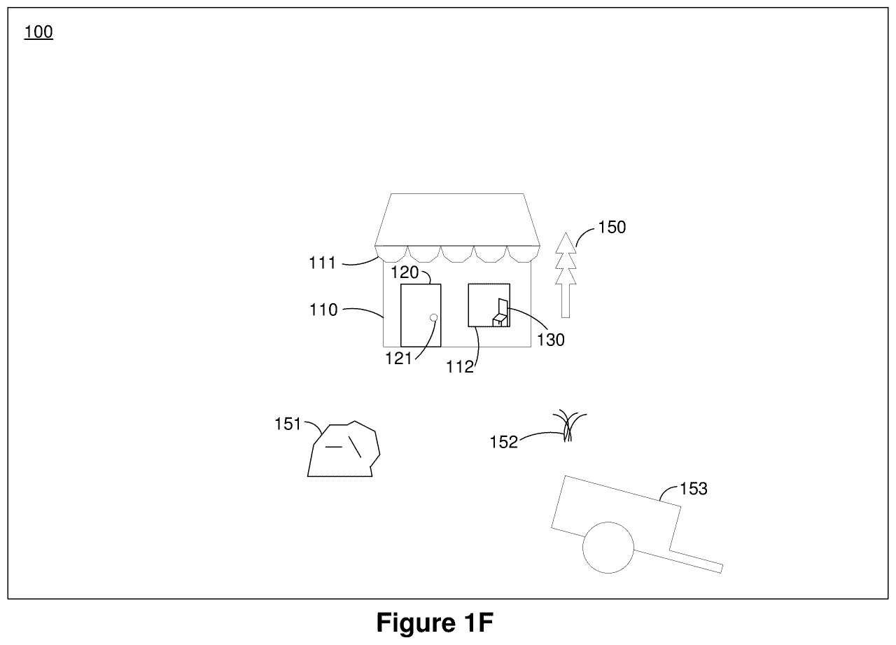

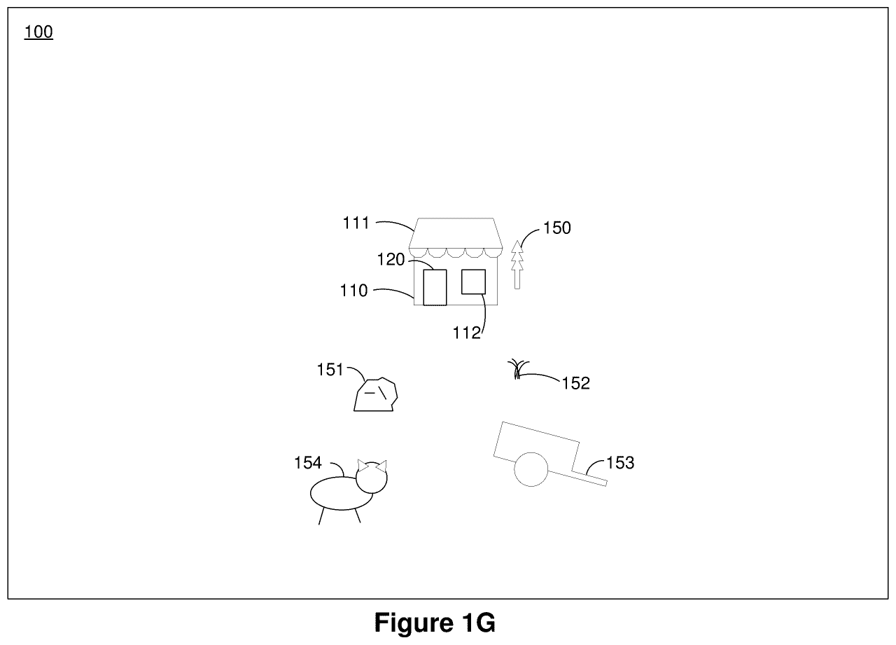

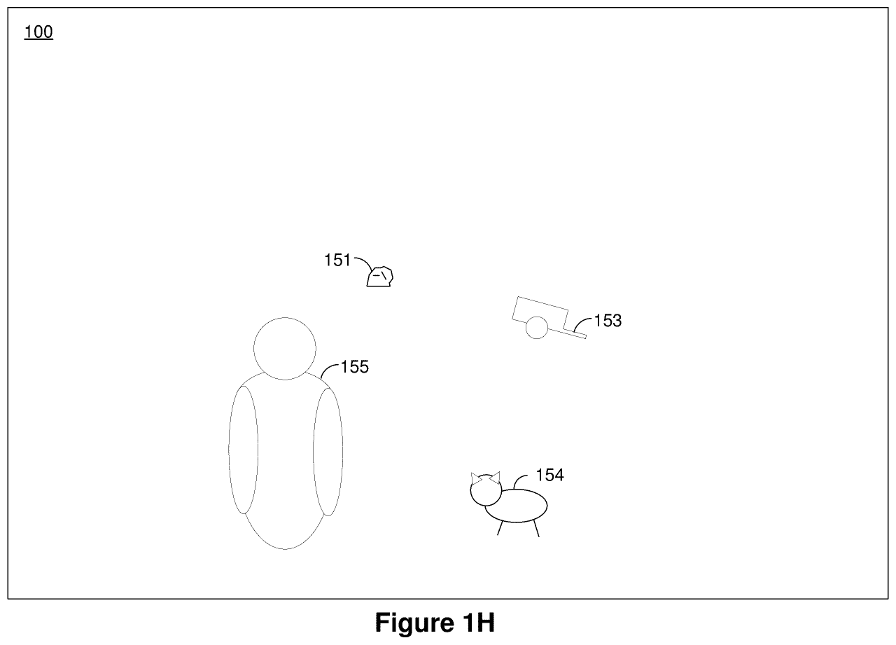

FIGS. 1A-1H illustrate a virtual environment 100 from a rendering perspective displayed, at least in part, by a display of an electronic device. In various implementations, the electronic device includes multiple displays (e.g., a left display positioned in front of a left eye of a user and a right display positioned in front of a right eye of the user) configured to provide a stereoscopic view of the virtual environment 100. For ease of illustration, FIGS. 1A-1H illustrate the virtual environment as presented on a single one of the multiple displays.

FIGS. 1A-1H illustrate the virtual environment 100 during a series of time periods. In various implementations, each time period is an instant, a fraction of a second, a few seconds, a few hours, a few days, or any length of time.

FIG. 1A illustrates the virtual environment 100 during a first time period. During the first time period, the virtual environment 100 includes a house 110 and a tree 150. The house 110 is rendered based on a house object stored in a memory of the electronic device and the tree 150 is rendered based on a tree object stored in the memory of the electronic device. The house object contains multiple meshes with different numbers of polygons for rendering the house 110 at various levels of detail. Each of the meshes of the house object includes polygons for rendering a roof 111 and a window 112. Further, the house object is associated with multiple child objects stored in the memory of the electronic device including a door object and a chair object. During the first time period, the house 110 includes a door 120 rendered based on the door object and a chair 130 rendered based on the chair object. The door object contains multiple meshes with different numbers of polygons for rendering the door 120 at various levels of detail. Some of the meshes of the door object include polygons for rendering a doorknob 121. During the first time period, the house 110, door 120, chair 130, and tree 150 are rendered at a first (and highest) level of detail. Thus, the roof 111 has round scallops and the doorknob 121 is a circle.

FIG. 1B illustrates the virtual environment 100 during a second time period subsequent to the first time period. Between the first time period and the second time period, a user has added a knocker 140 to the house 110. The knocker 140 is rendered based on a knocker object stored in the memory of the electronic device. Further, the knocker object is stored as a child object of the door object which is itself a child object of the house object. The knocker object contains multiple meshes with different numbers of polygons for rendering the knocker 140 at various levels of detail. During the second time period, the house 110, door 120, chair 130, knocker 140, and tree 150 are rendered at the first (and highest) level of detail. Thus, the roof 111 has round scallops, the doorknob 121 is a circle, and the knocker 140 is a ring.

FIG. 1C illustrates the virtual environment 100 during a third time period subsequent to the second time period. Between the second time period and the third time period, a user has moved the house 110 closer to the tree 150. In various implementations, the house object contains a set of coordinates in a virtual environment coordinate system. Thus, when the user moves the house 110, the set of coordinates in the virtual environment coordinate system are changed. Because the door object and chair object are child objects of the house object, moving the house 110 also moves the door 120 and the chair 130. Similarly, because the knocker object is a child object of the door object, moving the door 120 also moves the knocker 140. During the third time period, the house 110, door 120, chair 130, knocker 140, and tree 150 are still rendered at the first (and highest) level of detail. Thus, the roof 111 has round scallops, the doorknob 121 is a circle, and the knocker 140 is a ring.

FIG. 1D illustrates the virtual environment 100 during a fourth time period subsequent to the third time period. Between the third time period and the fourth time period, a user has moved the chair 130 within the house 110. In various implementations, the chair object contains a set of coordinates in a house coordinate system. Thus, when the user moves the chair 130, the set of coordinates in the house coordinate system are changed. In contrast, when moving the house 110 (as in FIG. 1C), the set of coordinates in the house coordinate system are unchanged. During the fourth time period, the house 110, door 120, chair 130, knocker 140, and tree 150 are still rendered at the first (and highest) level of detail. Thus, the roof 111 has round scallops, the doorknob 121 is a circle, and the knocker 140 is a ring.

FIG. 1E illustrates the virtual environment 100 during a fifth time period subsequent to the fourth time period. Between the fourth time period and the fifth time period, a user has moved the rendering perspective farther from the house 110 and the tree 150. From this farther rendering perspective, the virtual environment 100 includes a rock 151 and a grass tuft 152. The rock 151 is rendered based on a rock object stored in the memory of the electronic device. Similarly, the grass tuft 152 is rendered based on a grass tuft object stored in the memory of the electronic device. The rock object contains multiple meshes with different numbers of polygons for rendering the rock 151 at various levels of detail and the grass tuft object contains multiple meshes with different numbers of polygons for rendering the grass tuft 152 are various levels of detail. During the fifth time period, the rock 151 and the grass tuft 152 are rendered at a first (and highest) level of detail. In various implementations, the number of polygons that the electronic device can render is finite. Accordingly, in order to render the meshes of the rock 151 and the grass tuft 152, the number of polygons rendered for the house 110 and the tree 150 are reduced. In particular, the house 110 and the tree 150 are rendered at a second (and lower) level of detail. At the second level of detail, the house 110 is rendered with a mesh having less polygons than in the fourth time period of FIG. 1D. Thus, the roof 111 has angled scallops. Further, the door 120 is rendered with a mesh having less polygons than in the fourth time period of FIG. 1D. Thus, the doorknob 121 is an octagon. Further, the knocker 140 is rendered with a mesh having less polygons than in the fourth time period of FIG. 1D. Thus, the knocker 140 is an octagonal annulus. Thus, the level of detail of the house 110 is lowered by using a mesh of the house object having fewer polygons and lowering the detail of the rendering of a child object, e.g., the door object. Similarly, the level of detail of the door 120 is lowered by using a mesh of the door object having fewer polygons and lowering the detail of the rendering of a child object, e.g., the knocker object. The level of detail of the knocker 140 is lowered by using a mesh of the knocker object having fewer polygons.

In various implementations, the level of detail of an object is determined based on distance between the rendering perspective and the object. For example, when the distance is less than a first threshold, the object is rendered at a first (and highest) level of detail. When the distance is greater than the first threshold, but less than a second threshold, the object is rendered at a second (and lower) level of detail. When the distance is greater than the second threshold, but less than a third threshold, the object is rendered at a third (and lower) level of detail. When the distance is greater than a rendering threshold, the object is not rendered. In various implementations, the thresholds are different for different objects. In particular, the rendering threshold may be different for different objects. In various implementations, the rendering threshold may be referred to as a “draw distance.” In various implementations, there is a global rendering threshold (which may be referred to as a “global draw distance”) and any object with a distance from the rendering perspective farther from the global rendering threshold is not rendered.

FIG. 1F illustrates the virtual environment 100 during a sixth time period subsequent to the fifth time period. Between the fifth time period and the sixth time period, a user has moved the rendering perspective farther from the house 110 and the tree 150. From this farther rendering perspective, the virtual environment 100 includes a cart 153. The cart 153 is rendered based on a cart object stored in the memory of the electronic device. The cart object contains multiple meshes with different numbers of polygons for rendering the cart 153 at various levels of detail. During the sixth time period, the cart 153 is rendered at a first (and highest) level of detail. Similarly, the rock 151 and the grass tuft 152 are still rendered at a first (and highest) level of detail. However, in order to render the mesh of the cart 153 and the grass tuft 152, the number of polygons rendered for the house 110 and the tree 150 are reduced. In particular, the house 110 and the tree 150 are rendered at a third (and lower) level of detail. At the third level of detail, the house 110 is rendered with the same mesh as the fifth time period of FIG. 1E. Similarly, the door 120 is rendered with the same mesh as the fifth time period of FIG. 1E. Thus, the doorknob 121 is an octagon. However, at the third level of detail, the knocker 140 is not rendered. Thus, the level of detail of the house 110 is lowered by forgoing the rendering of a child object, e.g., the knocker object, of a child object, e.g., the door object.

FIG. 1G illustrates the virtual environment 100 during a seventh time period subsequent to the sixth time period. Between the sixth time period and the seventh time period, a user has moved the rendering perspective farther from the house 110 and the tree 150. From this farther rendering perspective, the virtual environment 100 includes a cat 154. The cat 154 is rendered based on a cat object stored in the memory of the electronic device. The cat object contains multiple meshes with different numbers of polygons for rendering the cat 154 at various levels of detail. During the seventh time period, the cat 154 is rendered with a first (and highest) level of detail. Similarly, the cart 153 is rendered with the first (and highest) level of detail. However, in order to render the mesh of the cat 154, the number of polygons rendered for the house 110, the tree 150, the rock 151, and the grass tuft 152 are reduced. In particular, rock 151 and the grass tuft 152 are rendered at a second (and lower) level of detail using meshes with fewer polygons than in the sixth time period of FIG. 1F. Further, the house 110 is rendered at a fourth (and lower) level of detail. At the fourth level of detail, the house 110 is rendered with the same mesh as in the sixth time period of FIG. 1F. However, the door 120 is rendered with a mesh having fewer polygons than the mesh used in the sixth time period of FIG. 1F. Thus, the doorknob 121 is absent. Further, the chair 130 is not rendered. Thus, the level of detail of the house 110 is lowered by rendering a child object, e.g., the door 120, with a mesh having fewer polygons and forgoing the rendering of a child object, e.g., the chair 130.

FIG. 1H illustrates the virtual environment 100 during an eight time period subsequent to the seventh time period. Between the seventh time period and the eighth time period, a user has moved the rendering perspective farther from the house 110 and the tree 150. From this farther rendering perspective, the virtual environment 100 includes a character 155. The character 155 is rendered based on a character object stored in the memory of the electronic device. The character object contains multiple meshes with different numbers of polygons for rendering the character 155 at various levels of detail. During the eighth time period, the character 155 is rendered with a first (and highest) level of detail. Similarly, the cat 154 and the cart 153 are still rendered with the first (and highest) level of detail. During the eighth time period, the rock 151 is still rendered with the second level of detail. However, in order to render the mesh of the character 155, the number of polygons rendered for the house 110, the tree 150, and the grass tuft 152 are reduced. In particular, the number of polygons rendered for the house 110, the tree 150, and the grass tuft 152 are reduced to zero as the house 110, the tree 150, and the grass tuft 152 are not rendered. Thus, the level of detail of the house 110 is lowered to zero by not rendering the house 110.

In various implementations, the house 110 and the tree 150 are not rendered because the distance to the house 110 and the tree 150 is greater than a global draw distance. However, in various implementations, even though the distance to the grass tuft 152 is less than the global draw distance, the grass tuft 152 is not rendered because the distance to the grass tuft is greater than an object-specific draw distance of the grass tuft 152.

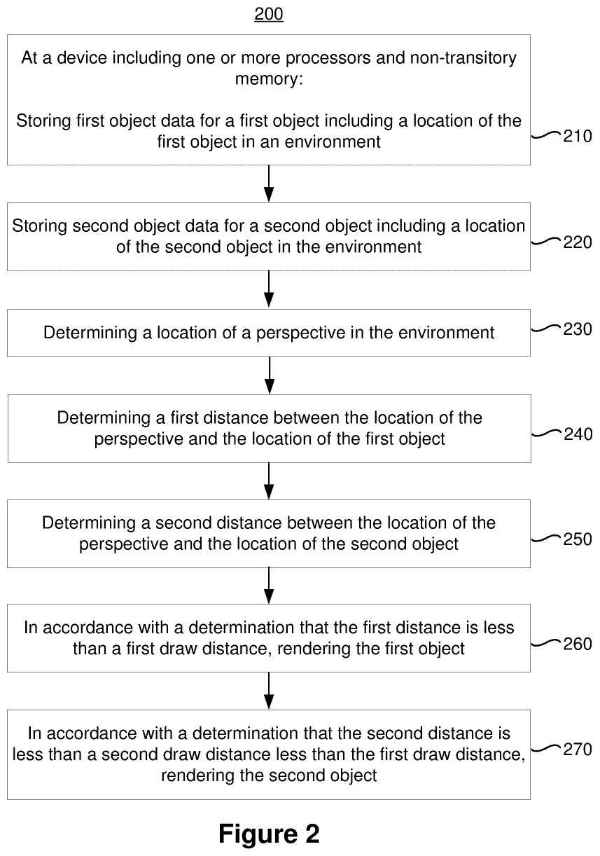

FIG. 2 is a flowchart representation of a method 200 of rendering objects in accordance with some implementations. In various implementations, the method 200 is performed by an electronic device. In various implementations, the method 200 is performed by a device one or more processors and non-transitory memory. In some implementations, the method 200 is performed by processing logic, including hardware, firmware, software, or a combination thereof. In some implementations, the method 200 is performed by a processor executing instructions (e.g., code) stored in a non-transitory computer-readable medium (e.g., a memory).

The method 200 begin, in block 210, with the electronic device storing first object data for a first object including a location of the first object in an environment. In various implementations, electronic device stores the location of the first object as a set of coordinates in a virtual environment coordinate system. In various implementations, the first object data further includes a mesh of the first object. In various implementations, the first object data includes multiple meshes of the first object with different numbers of polygons for rendering the first object at various levels of detail. In various implementations, the first object data includes a material of the first object that can be applied to a mesh. In various implementations, the first object data includes multiple materials of the first object with different resolutions for rendering the first object at various levels of detail. In various implementations, the first object data includes a first object-specific draw distance.

The method 200 continues, in block 220, with the electronic device storing second object data for a second object including a location of the second object in the environment. In various implementations, the electronic device stores the location of the second object as a set of coordinates in the virtual environment coordinate system. In various implementations, the electronic device stores the location of the second object as an offset from the location of the first object (e.g., a set of coordinates in a first object coordinate system). In various implementations, the second object data further includes a mesh of the second object. In various implementations, the second object data includes multiple meshes of the second object with different numbers of polygons for rendering the second object at various levels of detail. In various implementations, the second object data includes a material of the second object that can be applied to a mesh. In various implementations, the second object data includes multiple materials of the second object with different resolutions for rendering the second object at various levels of detail. In various implementations, the second object data includes a second object-specific draw distance.

In various implementations, the first object data and/or the second object data includes an association of the second object as a child object of the first object and/or an association of the first object as a parent object of the second object.

The method 200 continues, in block 230, with the electronic device determining a location of a perspective in the environment. In various implementations, a renderer renders an image including virtual objects from a certain perspective, which may include a position and orientation in the environment. The perspective may also be referred to as a “camera pose”. In various implementations, the perspective is a perspective of an avatar of a user. In various implementations, a user can input commands to change the perspective, e.g., by moving the avatar in the environment.

The method 200 continues, in block 240, with the electronic device determining a first distance between the location of the perspective and the location of the first object. The method 200 continues, in block 250, with the electronic device determining a second distance between the location of the perspective and the location of the second object. In various implementations, the second object is a child object of the first object and the second distance is presumed equal to the first distance. In other words, in various implementations, determining the first distance (in block 240) and determining the second distance (in block 250) is performed by determining a single distance to a parent object.

The method 200 continues, in block 260, with the electronic device, in accordance with a determination that the first distance is less than a first draw distance, rendering the first object from the perspective. For example, in FIG. 1F, the electronic device renders the house 110 in accordance with a determination that the distance to the house 110 is less than a first threshold, the global draw distance. In various implementations, the first draw distance is a global draw distance. In various implementations, the first draw distance is an object-specific draw distance.

As noted above, in various implementations, the first object data includes a mesh of the first object. Thus, in various implementations, rendering the first object (in block 260) is based on the mesh. As also noted above, in various implementations, the first object data includes a material of the first object. Thus, in various implementations, rendering the first object (in block 260) is based on the material. In various implementations, rendering the first object and the second object is further based on lighting conditions in the environment and/or other object and/or environmental parameters.

The method 200 continues, in block 270, with the electronic device, in accordance with a determination that the second distance is less than a second draw distance less than the first draw distance, rendering the second object from the perspective. For example, in FIG. 1G, the electronic device renders the grass tuft 152 in accordance with a determination that the distance to the grass tuft 152 is less than a second threshold, the object-specific draw distance of the grass tuft 152. Thus, in various implementations, the second draw distance is an object-specific draw distance.

In various implementations, the method 200 further includes the electronic device, in accordance with a determination that the second distance is less than the first draw distance and greater than the second draw distance, forgoing rendering the second object. For example, in FIG. 1H, even though the distance to the grass tuft 152 is less than the global draw distance, the electronic device does not render the grass tuft 152 because the distance is greater than the object-specific draw distance of the grass tuft 152.

In various implementations, the method 200 further includes the electronic device, in accordance with a determination that the first distance is greater than the first draw distance, forgoing rendering of the first object. For example, in FIG. 1H, the distance to the house 110 is greater than the global draw distance and the electronic device does not render the house 110.

In various implementations, the method 200 includes setting a level of detail of the first object based on the first distance. In various implementations, the first object data includes level of detail data specifying a plurality of levels of detail. In various implementations, each level of detail includes information regarding a mesh to used in rendering the first object, a material to be applied to the mesh, and whether one or more child objects of the first object are to be rendered. In various implementations, each level of detail is associated with a distance range at which the level of detail is used.

For example, a first level of detail used whenever the distance is below a first threshold specifies a first mesh, a first material, an indication that a first child object is to be rendered, and an indication that a second child object is to be rendered. A second level of detail used whenever the distance is between the first threshold and a second threshold specifies a second mesh, a second material, an indication that the first child object is to be rendered, and an indication that the second child object is to be rendered. A third level of detail used whenever the distance is between the second threshold and the global draw distance specifies the second mesh, the second material, an indication that the first child object is to be rendered, and an indication that the second child object is not to be rendered.

For example, in FIG. 1F, based on the distance to the house 110, the electronic device sets the level of detail of the house 110 to the third level of detail in which a lower polygon mesh is used and the door 120 and the chair 130 are rendered. Thus, in accordance with the distance being less than the global draw distance, the house 110 is rendered. Further, in accordance with the distance being less than an object-specific draw distance for the chair 130, the chair 130 is rendered. In contrast, in FIG. 1G, based on the increased distance to the house 110, the electronic device sets the level of detail of the house 110 to the fourth level of detail in which the lower polygon mesh is used, the door 120 is rendered, and the chair 130 is not rendered. Thus, in accordance with the increased distance being less than global draw distance the house 110 is rendered. However, in accordance with the increased distance being greater than the object-specific draw distance for the chair 130, the chair 130 is not rendered.

In various implementations, the method 200 further includes displaying a virtual environment including the first object and the second object.

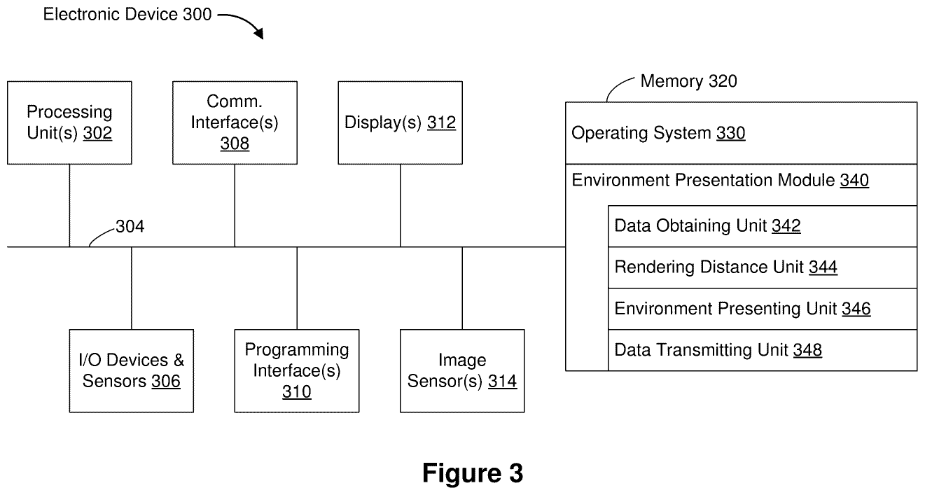

FIG. 3 is a block diagram of an example of an electronic device 300 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 300 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, one or more optional interior-and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 312 are configured to display a virtual environment. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. In one example, the electronic device 300 includes a single display. In another example, the electronic device includes a display for each eye of the user. In some implementations, the one or more displays 312 are capable of presenting XR (extended reality) and VR (virtual reality) content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the physical environment as would be viewed by the user if the electronic device 300 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an environment presentation module 340.

The operating system 330 includes procedures for handling various basic system services and for performing hardware dependent tasks. In some implementations, the environment presentation module 340 is configured to present an environment to the user via the one or more displays 312. To that end, in various implementations, the environment presentation module 340 includes a data obtaining unit 342, a rendering distance unit 344, an environment presenting unit 346, and a data transmitting unit 348.

In some implementations, the data obtaining unit 342 is configured to obtain data (e.g., presentation data, interaction data, sensor data, location data, etc.) from the other components of the electronic device 300 and/or a different electronic device. To that end, in various implementations, the data obtaining unit 342 includes instructions and/or logic therefor, and heuristics and metadata therefor.

In some implementations, the rendering distance unit 344 is configured to determine a distance to an object from a current perspective, and based on that distance, determine whether the object is to be rendered. To that end, in various implementations, the rendering distance unit 344 includes instructions and/or logic therefor, and heuristics and metadata therefor.

In some implementations, the environment presenting unit 346 is configured to selectively display, based on a distance to an object from a current perspective, a rendering of the object. To that end, in various implementations, the environment presenting unit 346 includes instructions and/or logic therefor, and heuristics and metadata therefor.

In some implementations, the data transmitting unit 348 is configured to transmit data (e.g., presentation data, location data, etc.) to other components of the electronic device 300 and/or a different electronic device. To that end, in various implementations, the data transmitting unit 348 includes instructions and/or logic therefor, and heuristics and metadata therefor.

Although the data obtaining unit 342, the rendering distance unit 344, the environment presenting unit 346, and the data transmitting unit 348 are shown as residing on a single device (e.g., the electronic device 300), it should be understood that in other implementations, any combination of the data obtaining unit 342, the rendering distance unit 344, the environment presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having one or more processors and non-transitory memory:
storing first object data for a first object including a location of the first object in an environment;
storing second object data for a second object including a location of the second object in the environment;
determining a location of a perspective in the environment;
determining a first distance between the location of the perspective and the location of the first object;
determining a second distance between the location of the perspective and the location of the second object;
in accordance with a determination that the first distance is less than a first draw distance, rendering the first object from the perspective; and
in accordance with a determination that the second distance less than a second draw distance less than the first draw distance, rendering the second object from the perspective.

2. The method of claim 1, wherein the first object data further includes a mesh of the first object and rendering the first object is based on the mesh.

3. The method of claim 1, wherein the first object data further includes a material of the first object and rendering the first object is based on the material.

4. The method of claim 1, further comprising, storing an association of the second object as a child object of the first object.

5. The method of claim 1, further comprising:
in accordance with a determination that the second distance is less than the first draw distance and greater than a second draw distance, forgoing rendering the second object.

6. The method of claim 1, further comprising:
in accordance with a determination that the first distance is greater than the first draw distance, forgoing rendering the first object.

7. The method of claim 1, further comprising setting a level of detail of the first object based on the first distance.

8. The method of claim 7, wherein the level of detail indicates whether one or more child objects of the first object are to be rendered.

9. The method of claim 1, further comprising displaying a virtual environment including the first object and the second object.

10. A device comprising:
a non-transitory memory; and
one or more processors to:
store first object data for a first object including a location of the first object in an environment;
store second object data for a second object including a location of the second object in the environment;
determine a location of a perspective in the environment;
determine a first distance between the location of the perspective and the location of the first object;
determine a second distance between the location of the perspective and the location of the second object;
in accordance with a determination that the first distance is less than a first draw distance, render the first object from the perspective; and
in accordance with a determination that the second distance less than a second draw distance less than the first draw distance, render the second object from the perspective.

11. The device of claim 10, wherein the first object data further includes a mesh of the first object and rendering the first object is based on the mesh.

12. The device of claim 10, wherein the first object data further includes a material of the first object and rendering the first object is based on the material.

13. The device of claim 10, wherein the one or more processors are further to store an association of the second object as a child object of the first object.

14. The device of claim 10, wherein the one or more processors are further to:
in accordance with a determination that the second distance is less than the first draw distance and greater than a second draw distance, forgo rendering the second object.

15. The device of claim 10, wherein the one or more processors are further to:
in accordance with a determination that the first distance is greater than the first draw distance, forgo rendering the first object.

16. The device of claim 10, wherein the one or more processors are further to set a level of detail of the first object based on the first distance.

17. The device of claim 16, wherein the level of detail indicates whether one or more child objects of the first object are to be rendered.

18. The device of claim 10, wherein the one or more processors are further to display a virtual environment including the first object and the second object.

19. A non-transitory memory storing one or more programs, which, when executed by one or more processors of a device including a display, cause the device to:
store first object data for a first object including a location of the first object in an environment;
store second object data for a second object including a location of the second object in the environment;
determine a location of a perspective in the environment;
determine a first distance between the location of the perspective and the location of the first object;
determine a second distance between the location of the perspective and the location of the second object;
in accordance with a determination that the first distance is less than a first draw distance, render the first object from the perspective; and
in accordance with a determination that the second distance less than a second draw distance less than the first draw distance, render the second object from the perspective.

20. The non-transitory memory of claim 19, wherein the one or more programs, when executed, further cause the device to store an association of the second object as a child object of the first object.
